(19) United States
(12) Patent Application Publication
(10) Pub. No.: US 2026/0360016 A1
(43) Pub. Date: Nov. 12, 2026

(54) METHOD FOR ENCODING AND DECODING A POINT CLOUD

(71) Applicant: BEIJING XIAOMI MOBILE SOFTWARE CO., LTD., Beijing (CN)

(72) Inventors: Wei ZHANG, Beijing (CN); Mary-Luc Georges Henry CHAMPEL, Beijing (CN)

(21) Appl. No.: 19/121,761

(22) PCT Filed: Oct. 18, 2022
(86) PCT No.: PCT/CN2022/125995

§ 371 Date: Apr. 16, 2025

(51) Int. Cl. G06T 9/00; G06T 9/40

(52) U.S. Cl. CPC G06T 9/001; G06T 9/40

(57) ABSTRACT

A method of encoding attributes of points of a point cloud to generate a bitstream of compressed point cloud data, including: determining whether a first occupied node count is greater than or equal to a first threshold value,; when the first occupied node count is less than the first threshold value, performing a first encoding on an attribute of the current node, the first encoding not including a prediction process in which third nodes are used, the third nodes including a parent node of the current node and nodes belonging to a same layer as the parent node; and when the first occupied node count is greater than or equal to the first threshold value, performing a second encoding on the attribute of the current node, the second encoding including the prediction process in which the third nodes are used.

### CROSS-REFERENCE TO RELATED APPLICATION

This application is a U.S. national phase of International Application No. PCT/CN2022/125995, filed Oct. 18, 2022, the entire content of which is incorporated herein by reference.

### TECHNICAL FIELD

The present application generally relates to the compression of attributes of points of a point cloud. In particular, the present application relates to a method of encoding and decoding, as well as an encoder and decoder for improved coding of attributes of a point cloud.

### BACKGROUND

As a format for the representation of 3D data, point clouds have recently gained traction as they are versatile in their capability of representing all types of 3D objects or scenes. Therefore, many use cases can be addressed by point clouds, which include, for example:
movie post-production,
real-time 3D immersive telepresence or VR/AR applications,
free-viewpoint video (for instance for sports viewing),
Geographical Information Systems (aka cartography),
culture heritage (storage of scans of rare objects into a digital form), and
autonomous driving, including 3D mapping of the environment and real-time Lidar data acquisition.

### SUMMARY

In a first aspect of the present invention, a method for encoding attributes of points of a point cloud is provided to generate a bitstream of compressed point cloud data, in which the point cloud's geometry is represented by a voxel-based structure with a plurality of nodes having parent-child relationships by recursively splitting a volumetric space containing the point cloud into sub-volumes each associated with a node of the voxel-based structure, including:
determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
when the first occupied node count is less than the first threshold value, performing a first encoding on an attribute of the current node, the first encoding not including a prediction process in which third nodes are used, the third nodes including a parent node of the current node and nodes belonging to a same layer as the parent node; and
when the first occupied node count is greater than or equal to the first threshold value, performing a second encoding on the attribute of the current node, the second encoding including the prediction process in which the third nodes are used.

In a second aspect of the present invention, a method for decoding a bitstream of compressed point cloud data is provided to generate attributes of points in a reconstructed point cloud, in which the point cloud's geometry is represented by a voxel-based structure with a plurality of nodes having parent-child relationships by recursively splitting a volumetric space containing the point cloud into sub-volumes each associated with a node of the voxel-based structure, including:
determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
when the first occupied node count is less than the first threshold value, performing a first decoding on an attribute of the current node, the first decoding not including a prediction process in which third nodes are used, the third nodes including a parent node of the current node and nodes belonging to a same layer as the parent node; and
when the first occupied node count is greater than or equal to the first threshold value, performing a second decoding on the attribute of the current node, the second decoding including the prediction process in which the third nodes are used.

In a third aspect of the present invention, an encoder is provided for encoding a point cloud to generate a bitstream of compressed point cloud data, in which the point cloud's geometry is represented by a voxel-based structure with a plurality of nodes having parent-child relationships by recursively splitting a volumetric space containing the point cloud into sub-volumes each associated with a node of the voxel-based structure, the encoder including:
a processor and
a memory storage device for storing instructions executable by the processor. The processor is configured to perform the method in the first aspect.

In a fourth aspect of the present invention, a decoder is provided for decoding a bitstream of compressed point cloud data to generate a reconstructed point cloud, in which a geometry of the point cloud is represented by a voxel-based structure with a plurality of nodes having parent-child relationships by recursively splitting a volumetric space containing the point cloud into sub-volumes each associated with a node of the voxel-based structure, the decoder including:
a processor and
a memory storage device for storing instructions executable by the processor. The processor is configured to perform the method in the second aspect.

In a fifth aspect of the present invention, a non-transitory computer-readable storage medium is provided to store processor-executed instructions that, when executed by a processor, cause the processor to perform the method in the first aspect.

### BRIEF DESCRIPTION OF THE DRAWINGS

FIG. 1 an embodiment of the method of encoding according to the present invention,

FIG. 2 an embodiment of the method of decoding according to the present invention,

FIG. 3 a schematic diagram illustrating an example of transform domain prediction and parameter definition according to the present invention,

FIG. 4 a detailed embodiment of the present invention,

FIG. 5 a schematic illustration of an encoder device and

FIG. 6 a schematic illustration of a decoder device.

### DETAILED DESCRIPTION OF THE EMBODIMENTS

The present application describes methods of encoding and encoder for encoding attributes of points in a point cloud, and methods of decoding and decoder for decoding a bitstream into attributes of points in a point cloud.

The point cloud is a set of points located in a 3D space, optionally with additional values attached to each of the points. These additional values are usually called point attributes. Consequently, a point cloud is a combination of a geometry (the 3D position of each point) and attributes.

Attributes may be, for example, three-component colors, material properties like reflectance and/or two-component normal vectors to a surface associated with the point.

Point clouds may be captured by various types of devices like an array of cameras, depth sensors, Lidars, and scanners, or maybe computer-generated (in movie post-production for example). Depending on the use cases, point clouds may have thousands to billions of points for cartography applications.

Raw representations of point clouds require a very high number of bits per point, with at least a dozen of bits per spatial component X, Y or Z, and optionally more bits for the attribute, say three times 10 bits for the colors. Practical deployment of point-cloud-based applications requires compression technologies that enable the storage and distribution of point clouds with reasonable storage and transmission infrastructures.

Compression may be lossy (like in video compression) for the distribution to and visualization by an end-user, for example on AR/VR glasses or any other 3D-capable device. Other use cases do require lossless compression, like medical applications or autonomous driving, to avoid altering the results of a decision obtained from the analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, initiated work items on point cloud compression. This has led to two standards, namely
MPEG-I part 5 (ISO/IEC 23090-5) or Video-based Point Cloud Compression (V-PCC)
MPEG-I part 9 (ISO/IEC 23090-9) or Geometry-based Point Cloud Compression (G-PCC)

The V-PCC coding method compresses a point cloud by performing multiple projections of a 3D object to obtain 2D patches that are packed into an image (or a video when dealing with moving point clouds). Obtained images or videos are then compressed using already existing image/video codecs, allowing for the leverage of already deployed image and video solutions. By its very nature, V-PCC is efficient only on dense and continuous point clouds because image/video codecs are unable to compress non-smooth patches as would be obtained from the projection of, for example, Lidar-acquired sparse geometry data.

The G-PCC coding method has two schemes for the compression of the geometry.

The first scheme is based on an occupancy tree (octree/quadtree/binary tree) representation of the point cloud geometry. Occupied nodes are split down until a certain size is reached, and occupied leaf nodes provide the location of points, typically at the center of these nodes. By using neighbor-based prediction techniques, high level of compression can be obtained for dense point clouds.

Sparse point clouds are also addressed by directly coding the position of point within a node with non-minimal size, by stopping the tree construction when only isolated points are present in a node; this technique is known as Direct Coding Mode (DCM).

The second scheme is based on a predictive tree, each node representing the 3D location of one point and the relation between nodes is spatial prediction from parent to children. This method can only address sparse point clouds and offers the advantage of lower latency and simpler decoding than the occupancy tree. However, compression performance is only marginally better, and the encoding is complex, relatively to the first occupancy-based method, intensively looking for the best predictor (among a long list of potential predictors) when constructing the predictive tree.

In both schemes, attribute (de)coding is performed after complete geometry (de)coding, leading to a two-pass coding. Thus, low latency is obtained by using slices that decompose the 3D space into sub-volumes that are coded independently, without prediction between the sub-volumes. This may heavily impact the compression performance when many slides are used.

An important use case is the transmission of Lidar data acquired by a moving vehicle. This usually requires a simple low-latency embarked encoder. Simple is required because the encoder is likely to be deployed on computing units perform other processing, like (semi-) autonomous driving, in parallel, thus limiting the processing power allocated to the point cloud encoder. Low latency is also required to allow for fast transmission from the car to a cloud in order to have a real-time view of the local traffic, based on multiple-vehicle acquisition, and take adequate fast decision based on the traffic information. While transmission latency can be low by using 5G, the encoder itself should not introduce too much latency of coding. Also, compression performance should not be sacrificed as the flow of data from millions of cars to the cloud is expected to be extremely heavy.

Combining encoder and decoder simplicity, low latency and compression performance is still a problem that has not been satisfactory solved by existing point cloud codecs.

Points attributes are coded based on coded Geometry coordinates which are used to help in decorrelating the attributes information according to spatial relationship/distances between points. In G-PCC there are mainly two methods for decorrelating and coding attributes: the first one is called RAHT for region adaptive hierarchical transform, and the second one is using one or more level of details (LoDs) and is then sometimes referred to as LoD or as predlift because it can be configured to be used as a predictive decorrelation method or as a lifting based decorrelation method.

The present invention relates to a method of encoding attributes of points of a point cloud to generate a bitstream of compressed point cloud data, in which the point cloud's geometry is represented by a voxel-based structure with a plurality of nodes having parent-child relationships by recursively splitting a volumetric space containing the point cloud into sub-volumes each associated with a node of the voxel-based structure, including the steps: determining whether a first occupied node count is greater than or equal to a first threshold value, the first occupied node count being a total number of occupied nodes that are nodes each including at least one three-dimensional point, the occupied nodes being included in the first node count being occupied child node of a current node in an N-ary tree structure of three-dimensional points included in point cloud data, N being an integer greater than or equal to 2; when the first occupied node count is less than the first threshold value, performing a first encoding on the attribute of the current node, the first encoding not including a prediction process in which third nodes are used, the third nodes including a parent node of the current node and nodes belonging to a same layer as the parent node; and when the first occupied node count is greater than or equal to the first threshold value, performing a second encoding on the attribute of the current node, the second encoding including the prediction process in which the third nodes are used.

Other aspects and features of the present application will be understood by those ordinary skill in the art from a review of the following description of examples in conjunction with the accompanying figures.

At times in the description below, the terms “node” and “sub-volume” may be used interchangeably. It will be appreciated that a node is associated with a sub-volume. The node is a particular point on the tree that may be an internal node or a leaf node. The sub-volume is the bounded physical space that the node represents. The term “volume” may be used to refer to the largest bounded space defined for containing the point cloud. The volume is recursively divided into sub-volumes to build out a tree structure of interconnected nodes for coding the point cloud data. Additionally, the term “parent node” refers to a node in the next higher level of the tree. While the node might be at the level or depth D in the tree, the parent node is a node at the level or depth D−1.

A point cloud is a set of points in a three-dimensional coordinate system. The points are often intended to represent the external surface of one or more objects. Each point has a location (position) in the three-dimensional coordinate system. The position may be represented by three coordinates (X, Y, Z), which can be Cartesian or any other coordinate system. The points have further associated attributes, such as color, which may also be a three-component value in some cases, such as R, G, B or Y, Cb, Cr. Other associated attributes may include transparency, reflectance, a normal vector, etc., depending on the desired application for the point cloud data.

Point clouds can be static or dynamic. For example, a detailed scan or mapping of an object or topography may be static point cloud data. The LiDAR-based scanning of an environment for machine-vision purposes may be dynamic in that the point cloud (at least potentially) changes over time, e.g., with each successive scan of a volume. The dynamic point cloud is therefore a time-ordered sequence of point clouds.

Point cloud data may be used in a number of applications, including conservation (scanning of historical or cultural objects), mapping, machine vision (such as autonomous or semi-autonomous cars), and virtual reality systems, to give some examples. Dynamic point cloud data for applications like machine vision can be quite different from static point cloud data like that for conservation purposes. Automotive vision, for example, typically involves relatively small resolution, non-coloured and highly dynamic point clouds obtained through LiDAR (or similar) sensors with a high frequency of capture. The objective of such point clouds is not for human consumption or viewing but rather for machine object detection/classification in a decision process. As an example, typical LiDAR frames contain on the order of tens of thousands of points, whereas high quality virtual reality applications require several millions of points. It may be expected that there will be a demand for higher resolution data over time as computational speed increases and new applications are found.

While point cloud data is useful, a lack of effective and efficient compression of the attributes and geometry of such a point cloud, i.e., encoding and decoding processes, may hamper adoption and deployment.

One of the more common mechanisms for coding point cloud data is through using tree-based structures. In a tree-based structure, the bounding three-dimensional volume for the point cloud is recursively divided into sub-volumes. Nodes of the tree correspond to sub-volumes. The decision of whether or not to further divide a sub-volume may be based on the resolution of the tree and/or whether there are any points contained in the sub-volume. A leaf node may have an occupancy flag that indicates whether its associated sub-volume contains a point or not. Splitting flags may signal whether a node has child nodes (i.e. whether a current volume has been further split into sub-volumes). These flags may be entropy coded in some cases and in some cases, predictive coding may be used. A commonly-used tree structure is an octree. In this structure, the volumes/sub-volumes are all cubes and each split of a sub-volume results in eight further sub-volumes/sub-cubes.

The basic process for creating an octree to code a point cloud may include:
Start with a bounding volume (cube) containing the point cloud in a coordinate system;
1. Split the volume into 8 sub-volumes (eight sub-cubes);
2. For each sub-volume, mark the sub-volume with 0 if the sub-volume is empty, or with 1if there is at least one point in it;
3. For all sub-volumes marked with 1, repeat (2) to split those sub-volumes, until a maximum depth of splitting is reached; and
4. For all leaf sub-volumes (sub-cubes) of maximum depth, mark the leaf cube with 1 if it is non-empty, 0 otherwise.

The tree may be traversed in a pre-defined order (breadth-first or depth-first, and in accordance with a scan pattern/order within each divided sub-volume) to produce a sequence of bits representing the occupancy pattern of each node.

As mentioned above points in the point cloud may include attributes. These attributes are coded independently from the coding of the geometry of the point cloud. Thus, each occupied node, i.e., a node including at least one point of the point cloud is associated with one or more attributes in order to further specify the properties of the point cloud.

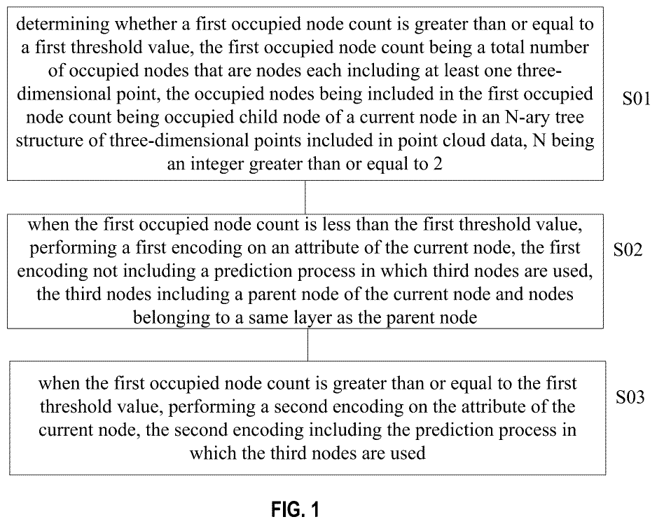

The present invention provides a method for encoding attributes of points of a point cloud. The method is shown in FIG. 1.

A method of encoding attributes of points of a point cloud to generate a bitstream of compressed point cloud data, in which the point cloud's geometry is represented by a voxel-based structure with a plurality of nodes having parent-child relationships by recursively splitting a volumetric space containing the point cloud into sub-volumes each associated with a node of the voxel-based structure, including the steps:
S01: determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
S02: when the first occupied node count is less than the first threshold value, performing a first encoding on an attribute of the current node, the first encoding not including a prediction process in which third nodes are used, the third nodes including a parent node of the current node and nodes belonging to a same layer as the parent node; and
S03: when the first occupied node count is greater than or equal to the first threshold value, performing a second encoding on the attribute of the current node, the second encoding including the prediction process in which the third nodes are used.

According to step S01, it is first checked whether the total number of the occupied child node is less than a first threshold value. If such a number is less than the first threshold value, the attribute will be encoded in a manner other than predictive coding. Only when such a number is greater than or equal to the first threshold, the predictive coding might proceed. Therefore, whether to use a prediction process for attribute encoding can be appropriately selected, if not necessary, the prediction process can be terminated at a very early stage and therefore, the encoding efficiency can be improved.

In one embodiment the first threshold value is 2. Therefore, in case there is only one occupied child in the current node, the transform of the original and the predicted attribute value only results in one DC coefficient, no AC coefficient, and thus no AC coefficient residuals need to be coded. This avoids the unnecessary time-consuming predictive process, and the coding efficiency is further improved by providing such an appropriate first threshold value. The details of the predictive process are well-known in the art. For example, is known from “G-PCC CE13.18 report on upsampled transform domain prediction in RAHT, ISO/IEC JTC1/SC29 WG 11 Doc. m49380, Gothenburg, SE, July 2019” which is hereby incorporated by reference.

In one embodiment the method further comprises: before performing the second encoding on the attribute of the current node, determining whether a second occupied node count is greater than or equal to a second threshold value, the second occupied node count being a total number of occupied nodes included in second nodes including a grandparent node of the current node and nodes belonging to a same layer as the grandparent node; when the second occupied node count is less than the second threshold value, performing the first encoding on the attribute of the current node and skipping the second encoding; when the second occupied node count is greater than or equal to the second threshold value, searching nodes belonging to a same layer as a parent node of the current node; calculating a third occupied node count, the third occupied node count being a total number of occupied nodes included in third nodes including the parent node of the current node and nodes belonging to a same layer as the parent node; determining whether the third occupied node count is greater than or equal to a third threshold value; when the third occupied node count is less than the third threshold value, performing the first encoding on the attribute of the current node and skipping the second encoding; when the third occupied node count is greater than or equal to the third threshold value, performing the second encoding on the attribute of the current node.

Thus, the entire procedure of determining whether to apply predictive coding (i.e., the second encoding) is further optimized. In particular, it is first checked whether the number occupied child node of the current node is large enough (i.e., larger or than or equal to a first threshold), only in case this number is large enough, further determination of whether to apply predictive coding is performed. It is secondly checked whether the number of occupied grandparent neighbor nodes is greater or equal to a second threshold. If it is true, the parent neighbor nodes are searched, and the number of occupied parent neighbor nodes is counted. Then if the number of occupied parent neighbor nodes is greater or equal to a third threshold, the predictive coding is applied. Thus, in other words, if either the number of occupied grandparent neighbor nodes or the number of occupied parent neighbor nodes is less than the corresponding threshold, the time-consuming prediction of the attribute will be terminated at an early stage. The two additional conditions set (i.e., the second and the third threshold) before performing the predictive coding when applying together with the checking the first condition (i.e., the first threshold) produces a synergistic technical effect that the procedure of predictive coding may be terminated at an even earlier stage to avoid the time-consuming searching of parent node if the first condition is not met. Therefore, the entire technical solution provides an overall optimal encoding procedure which only applies predictive coding whenever necessary.

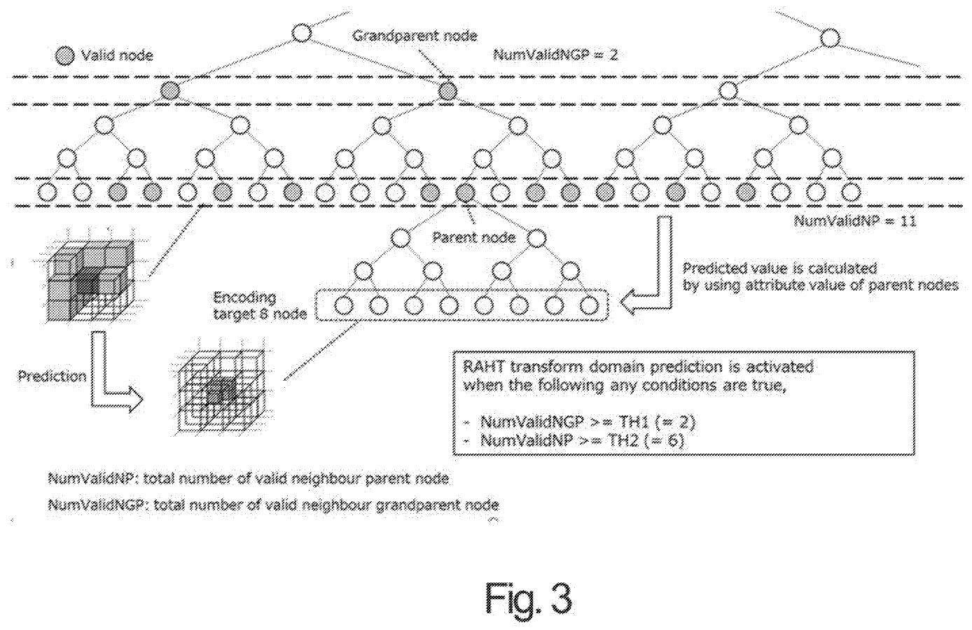

Referring to FIG. 3, showing an example of the transform domain prediction and some of the parameter definitions of the invention. Therein, occupied nodes (i.e., valid nodes) are shaded, and non-occupied nodes are transparent. Therefore, in this example, the number of occupied nodes in a grandparent level (i.e., grandparent level of the target 8 sub-modes to be coded) Num ValidNGP (i.e., the second occupied node count) is 2. The number of occupied nodes in a parent level (i.e., parent level of the target 8 sub-modes to be coded) Num ValidNP (i.e., the third occupied node count) is 11. The corresponding thresholds TH1 (i.e., the second threshold value) and TH2 (i.e., the third threshold value) are set to 2 and 6 respectively. Thus, in case the number of occupied child nodes is greater than or equal to the first threshold, the other two conditions for checking grandparent nodes and parent nodes are also met. Therefore, the encoding process continues with predictive coding, using the attribute value of parent nodes for a prediction. As can be taken from the bottom left sub-figure of FIG. 3, the occupied parent nodes are shaded, which are used to predict the target 8 sub-nodes shown to the right of it. The detail of the prediction is well-known in the art. For the sake of conciseness, the technique is not described in detail here as the gist of the present invention is to selectively apply the predictive coding technology instead of the predictive coding per se.

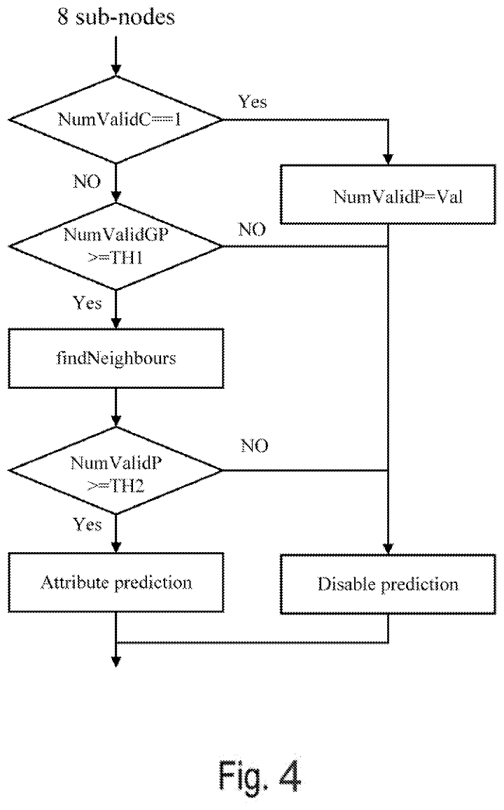

Referring to FIG. 4, showing a detailed embodiment of the present invention. If Num ValidC (i.e., the number of occupied child nodes of the current node) is equal to 1, the attribute prediction is disabled. Under this condition, the value of Num ValidP might have a default value (e.g., zero) since the parent neighbor search is skipped. This might cause that the predictions at the child level are forced to be terminated. To avoid the situation, Num ValidP (i.e., number of occupied parent nodes) is set to a value larger than TH2 (i.e., the third threshold), for example, Val=19 in the proposed method when Num ValidC=1.

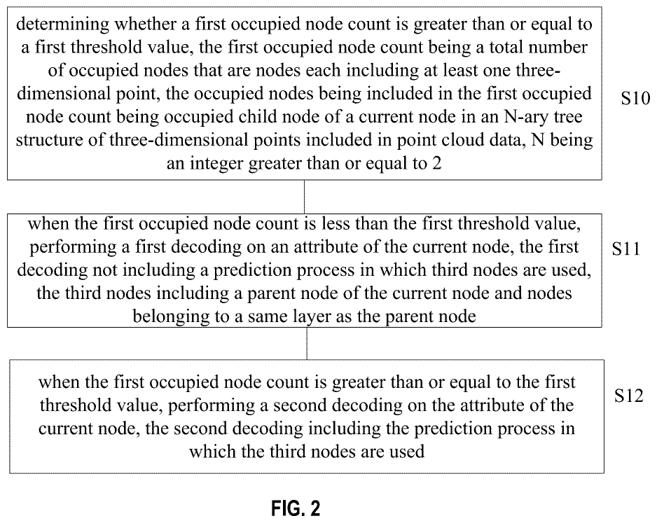

The present invention further provides a method for decoding from a bitstream, attributes of points of a point cloud, the method is shown in FIG. 2.

A method of decoding a bitstream of compressed point cloud data to generate attributes of points of a point cloud, in which the point cloud's geometry is represented by a voxel-based structure with a plurality of nodes having parent-child relationships by recursively splitting a volumetric space containing the point cloud into sub-volumes each associated with a node of the voxel-based structure, including the steps:
S10: determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
S11: when the first occupied node count is less than the first threshold value, performing a first decoding on an attribute of the current node, the first decoding not including a prediction process in which third nodes are used, the third nodes including a parent node of the current node and nodes belonging to a same layer as the parent node; and
S12: when the first occupied node count is greater than or equal to the first threshold value, performing a second decoding on the attribute of the current node, the second decoding including the prediction process in which the third nodes are used.

In some embodiments, the method of decoding is further built according to the embodiments described above with respect to the method for encoding. These features can be freely combined with the method of decoding.

Different embodiments described hereabove can be freely combined. In particular, the threshold values can be freely chosen and combined to meet the needs of the specific implementation.

Simulations were run on top of the TMC13v14 platform. Results under both C1 (lossless-geom-lossy-attrs) and C2(lossy-geom-lossy-attrs) conditions are evaluated. Results show that the proposed method according to the present invention can significantly reduce the encoding/decoding time while having no impact on the performance.

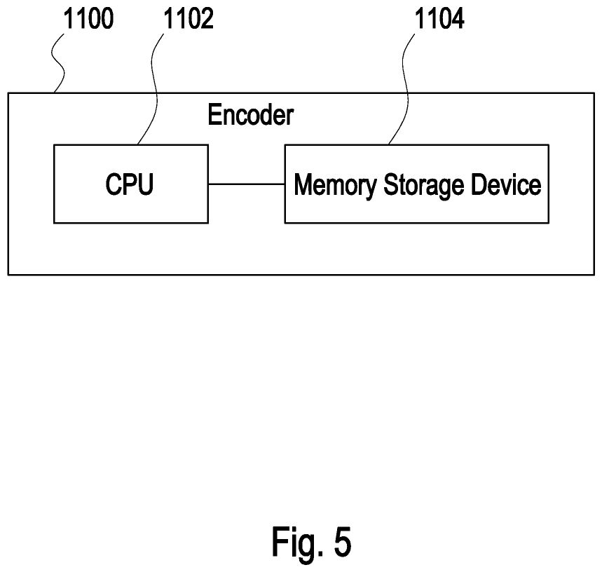

Reference is now made to FIG. 5, which shows a simplified block diagram of an example embodiment of an encoder 1100. The encoder 1100 includes a processor 1102 and a memory storage device 1104. The memory storage device 1104 may store a computer program or application containing instructions that, when executed, cause the processor 1102 to perform operations such as those described herein. For example, the instructions may encode and output bitstreams encoded in accordance with the methods described herein. It will be understood that the instructions may be stored on a non-transitory computer-readable medium, such as a compact disc, flash memory device, random access memory, hard drive, etc. When the instructions are executed, the processor 1102 carries out the operations and functions specified in the instructions so as to operate as a special-purpose processor that implements the described process(es). Such a processor may be referred to as a “processor circuit” or “processor circuitry” in some examples.

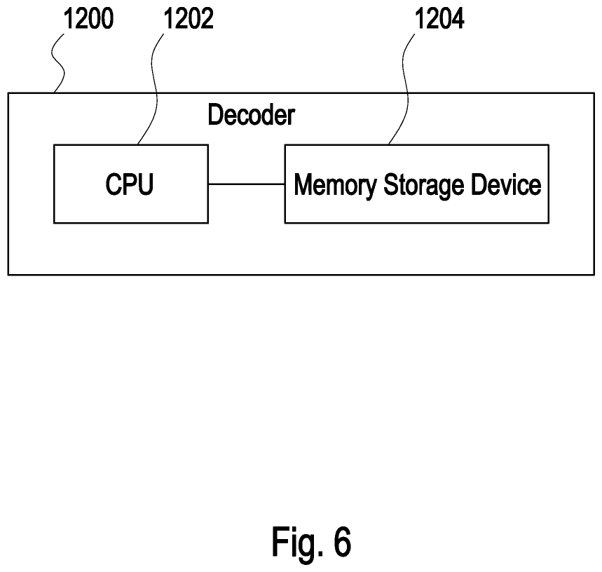

Reference is now also made to FIG. 6, which shows a simplified block diagram of an example embodiment of a decoder 1200. The decoder 1200 includes a processor 1202 and a memory storage device 1204. The memory storage device 1204 may include a computer program or application containing instructions that, when executed, cause the processor 1202 to perform operations such as those described herein. It will be understood that the instructions may be stored on a computer-readable medium, such as a compact disc, flash memory device, random access memory, hard drive, etc. When the instructions are executed, the processor 1202 carries out the operations and functions specified in the instructions so as to operate as a special-purpose processor that implements the described process(es) and methods. Such a processor may be referred to as a “processor circuit” or “processor circuitry” in some examples.

It will be appreciated that the decoder and/or encoder according to the present application may be implemented in a number of computing devices, including, without limitation, servers, suitably programmed general purpose computers, machine vision systems, and mobile devices. The decoder or encoder may be implemented by way of software containing instructions for configuring a processor or processors to carry out the functions described herein. The software instructions may be stored on any suitable non-transitory computer-readable memory, including CDs, RAM, ROM, Flash memory, etc.

It will be understood that the decoder and/or encoder described herein and the module, routine, process, thread, or other software component implementing the described method/process for configuring the encoder or decoder may be realized using standard computer programming techniques and languages. The present application is not limited to particular processors, computer languages, computer programming conventions, data structures, other such implementation details. Those skilled in the art will recognize that the described processes may be implemented as a part of computer-executable code stored in volatile or non-volatile memory, as part of an application-specific integrated chip (ASIC), etc.

Certain adaptations and modifications of the described embodiments can be made. Therefore, the above discussed embodiments are considered to be illustrative and not restrictive. In particular, embodiments can be freely combined with each other.

1. A method of encoding attributes of points of a point cloud to generate a bitstream of compressed point cloud data, wherein a geometry of the point cloud is represented by a voxel-based structure with a plurality of nodes having parent-child relationships by recursively splitting a volumetric space containing the point cloud into sub-volumes each associated with a node of the voxel-based structure, comprising:
determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
when the first occupied node count is less than the first threshold value, performing a first encoding on an attribute of the current node, the first encoding not including a prediction process in which third nodes are used, the third nodes including a parent node of the current node and nodes belonging to a same layer as the parent node; and
when the first occupied node count is greater than or equal to the first threshold value, performing a second encoding on the attribute of the current node, the second encoding including the prediction process in which the third nodes are used.

2. The method according to claim 1, wherein the first threshold value is 2.

3. The method according to claim 1, further comprising:
before performing the second encoding on the attribute of the current node, determining whether a second occupied node count is greater than or equal to a second threshold value, the second occupied node count being a total number of occupied nodes included in second nodes including a grandparent node of the current node and nodes belonging to a same layer as the grandparent node;
when the second occupied node count is less than the second threshold value, performing the first encoding on the attribute of the current node and skipping the second encoding;
when the second occupied node count is greater than or equal to the second threshold value, searching nodes belonging to a same layer as a parent node of the current node;
calculating a third occupied node count, the third occupied node count being a total number of occupied nodes included in the third nodes;
determining whether the third occupied node count is greater than or equal to a third threshold value;
when the third occupied node count is less than the third threshold value, performing the first encoding on the attribute of the current node and skipping the second encoding; and
when the third occupied node count is greater than or equal to the third threshold value, performing the second encoding on the attribute of the current node.

4. The method according to claim 3, wherein when the first occupied node count is less than the first threshold value, setting the third occupied node count larger than the third threshold value, the third occupied node count being set to 19.

5. A method of decoding a bitstream of compressed point cloud data to generate attributes of points of a point cloud, wherein a geometry of the point cloud is represented by a voxel-based structure with a plurality of nodes having parent-child relationships by recursively splitting a volumetric space containing the point cloud into sub-volumes each associated with a node of the voxel-based structure, comprising:
determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
when the first occupied node count is less than the first threshold value, performing a first decoding on an attribute of the current node, the first decoding not including a prediction process in which third nodes are used, the third nodes including a parent node of the current node and nodes belonging to a same layer as the parent node; and
when the first occupied node count is greater than or equal to the first threshold value, performing a second decoding on the attribute of the current node, the second decoding including the prediction process in which the third nodes are used.

6. The method according to claim 5, wherein the first threshold value is 2.

7. The method according to claim 5, further comprising:
before performing the second decoding on the attribute of the current node, determining whether a second occupied node count is greater than or equal to a second threshold value, the second occupied node count being a total number of occupied nodes included in second nodes including a grandparent node of the current node and nodes belonging to a same layer as the grandparent node;
when the second occupied node count is less than the second threshold value, performing the first decoding on the attribute of the current node and skipping the second decoding;
when the second occupied node count is greater than or equal to the second threshold value, searching nodes belonging to a same layer as a parent node of the current node;
calculating a third occupied node count, the third occupied node count being a total number of occupied nodes included in the third nodes;
determining whether the third occupied node count is greater than or equal to a third threshold value;
when the third occupied node count is less than the third threshold value, performing the first decoding on the attribute of the current node and skipping the second decoding; and
when the third occupied node count is greater than or equal to the third threshold value, performing the second decoding on the attribute of the current node.

8. The method according to claim 7, wherein when the first occupied node count is less than the first threshold value, setting the third occupied node count lager than the third threshold value, the third occupied node count being set to 19.

9. An encoder for encoding attributes of points of a point cloud to generate a bitstream of compressed point cloud data, wherein a geometry of the point cloud is represented by a voxel-based structure with a plurality of nodes having parent-child relationships by recursively splitting a volumetric space containing the point cloud into sub-volumes each associated with a node of the voxel-based structure, the encoder comprising:
a processor and
a memory storage device for storing instructions executable by the processor, wherein the processor is configured to:
determine whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
when the first occupied node count is less than the first threshold value, perform a first encoding on an attribute of the current node, the first encoding not including a prediction process in which third nodes are used, the third nodes including a parent node of the current node and nodes belonging to a same layer as the parent node; and
when the first occupied node count is greater than or equal to the first threshold value, perform a second encoding on the attribute of the current node, the second encoding including the prediction process in which the third nodes are used.

10. A decoder for decoding a bitstream of compressed point cloud data to generate attributes of points of a reconstructed point cloud, wherein a geometry of the point cloud is represented by a voxel-based structure with a plurality of nodes having parent-child relationships by recursively splitting a volumetric space containing the point cloud into sub-volumes each associated with a node of the voxel-bases structure, the decoder comprising:
a processor and
a memory storage device for storing instructions executable by the processor, wherein the processor is configured to execute the method according to claim 5,
wherein the method comprises:
determining whether a first occupied node count is greater than or equal to a first threshold value, the first occupied node count being a total number of occupied nodes that are nodes each including at least one three-dimensional point, the occupied nodes being included in the first occupied node count being occupied child node of a current node in an N-ary tree structure of three-dimensional points included in point cloud data, N being an integer greater than or equal to 2;
when the first occupied node count is less than the first threshold value, performing a first decoding on an attribute of the current node, the first decoding not including a prediction process in which third nodes are used, the third nodes including a parent node of the current node and nodes belonging to a same layer as the parent node; and
when the first occupied node count is greater than or equal to the first threshold value, performing a second decoding on the attribute of the current node, the second decoding including the prediction process in which the third nodes are used. when

11. (canceled)

12. The encoder according to claim 8, wherein the first threshold value is 2.

13. The encoder according to claim 8, wherein the processor is configured to:
before performing the second encoding on the attribute of the current node, determine whether a second occupied node count is greater than or equal to a second threshold value, the second occupied node count being a total number of occupied nodes included in second nodes including a grandparent node of the current node and nodes belonging to a same layer as the grandparent node;
when the second occupied node count is less than the second threshold value, perform the first encoding on the attribute of the current node and skipping the second encoding;
when the second occupied node count is greater than or equal to the second threshold value, search nodes belonging to a same layer as a parent node of the current node;
calculate a third occupied node count, the third occupied node count being a total number of occupied nodes included in the third nodes;
determine whether the third occupied node count is greater than or equal to a third threshold value;
when the third occupied node count is less than the third threshold value, perform the first encoding on the attribute of the current node and skipping the second encoding; and
when the third occupied node count is greater than or equal to the third threshold value, perform the second encoding on the attribute of the current node.

14. The encoder according to claim 13, wherein when the first occupied node count is less than the first threshold value, setting the third occupied node count lager than the third threshold value, the third occupied node count being set to 19.

15. The decoder according to claim 10, wherein the first threshold value is 2.

16. The decoder according to claim 10, wherein the method further comprises:
before performing the second decoding on the attribute of the current node, determining whether a second occupied node count is greater than or equal to a second threshold value, the second occupied node count being a total number of occupied nodes included in second nodes including a grandparent node of the current node and nodes belonging to a same layer as the grandparent node;
when the second occupied node count is less than the second threshold value, performing the first decoding on the attribute of the current node and skipping the second decoding;
when the second occupied node count is greater than or equal to the second threshold value, searching nodes belonging to a same layer as a parent node of the current node;
calculating a third occupied node count, the third occupied node count being a total number of occupied nodes included in the third nodes;
determining whether the third occupied node count is greater than or equal to a third threshold value;
when the third occupied node count is less than the third threshold value, performing the first decoding on the attribute of the current node and skipping the second decoding; and
when the third occupied node count is greater than or equal to the third threshold value, performing the second decoding on the attribute of the current node.

17. The decoder according to claim 16, wherein when the first occupied node count is less than the first threshold value, setting the third occupied node count lager than the third threshold value, the third occupied node count being set to 19.
